(19) United States
(12) Patent Application Publication
(10) Pub. No.: US 2025/0095638 A1
(43) Pub. Date: Mar. 20, 2025

(54) ZERO-SHOT INTENT CLASSIFICATION USING A SEMANTIC SIMILARITY AWARE CONTRASTIVE LOSS AND LARGE LANGUAGE MODEL

(71) Applicant: SAMSUNG ELECTRONICS CO., LTD., Suwon-si (KR)

(72) Inventors: Jaejin CHO, Mountain View, CA (US); Rakshith Sharma Srinivasa, Sunnyvale, CA (US); Chou-chang Yang, San Jose, CA (US); Yashas Malur Saidutta, Menlo Park, CA (US); Ching-Hua Lee, Mountain View, CA (US); Yilin Shen, Mountain View, CA (US); Hongxia Jin, San Jose, CA (US)

(73) Assignee: SAMSUNG ELECTRONICS CO., LTD., Suwon-si (KR)

(21) Appl. No.: 18/891,686

(22) Filed: Sep. 20, 2024

Related U.S. Application Data
(60) Provisional application No. 63/539,565, filed on Sep. 20, 2023.

(51) Int. Cl. G10L 15/06; G10L 15/18; G10L 15/183

(52) U.S. Cl. CPC G10L 15/063; G10L 15/1815; G10L 15/183; G10L 2015/0635

(57) ABSTRACT

A method includes: receiving one or more training text sentences; generating one or more training vectors based on inputting the one or more training sentences input into a text encoder, the one or more training vectors corresponding to one or more operations that an electronic device is configured to perform; generating one or more speech vectors based on one or more speech utterances input into a speech encoder; generating a similarity matrix that compares each of the one or more training vectors with each of the one or more speech vectors; and updating at least one of the text encoder and the speech encoder based on the similarity matrix.

### CROSS-REFERENCE TO RELATED APPLICATION

This application claims priority to U.S. provisional application No. 63/539,565 filed on Sep. 20, 2023, the entire contents of which are incorporated herein by reference.

### BACKGROUND

### 1. Field

This disclosure is directed to zero-shot intent classification using a semantic similarity aware contrastive loss and large language model (LLM).

### 2. Related Art

Spoken Language Understanding (SLU) assists human-computer interaction (e.g., in conversational agents) based on a user's speech. The two main tasks in SLU are utterance-level classification (e.g., for domain or intent), and sequence tagging/labeling such as named entity recognition (NER) or slot filling.

Speech intent classification has been tackled mainly in a supervised manner. However, to use a trained model for new intent classes, corresponding data for further training is necessary. This entails data collection and annotation, which are time-consuming and costly. Recently, self-supervised speech models have been explored, enabling more effective fine-tuning and reducing the data size required for the target domain. However, this still necessitates supervised fine tuning of a pre-trained model.

Traditional approaches to speech intent classification have relied on datasets annotated with intent labels corresponding to speech utterances. However, the creation of such datasets is expensive and time-consuming primarily due to the intensive labor required for accurate intent annotation. Consequently, the scarcity of these datasets generally result in models that are less adaptable and overly specialized to the domains in which they were initially trained. Although fine-tuning is a potential solution for adapting models to new domains, it demands additional domain-specific data. As a result, existing methods cannot effectively treat the domain mismatch between the pre-training and fine-tuning phases.

### SUMMARY

According to an aspect of the disclosure, a method performed by at least one processor comprises receiving one or more training text sentences; generating one or more training vectors based on inputting the one or more training sentences input into a text encoder, the one or more training vectors corresponding to one or more operations that an electronic device is configured to perform; generating one or more speech vectors based on one or more speech utterances input into a speech encoder; generating a similarity matrix that compares each of the one or more training vectors with each of the one or more speech vectors; and updating at least one of the text encoder and the speech encoder based on the similarity matrix.

According to an aspect of the of disclosure, a method performed by at least one processor, the method comprising: receiving, from a large language model, one or more training text sentences based on one or more text prompts input into the LLM; generating one or more class vectors based on the one or more training sentences input into a pre-trained text encoder, the one or more class vectors corresponding to one or more operations that an electronic device is configured to perform; generating a speech vector based on a speech utterance input into a pre-trained speech encoder; generating a similarity score between each class vector and the speech vector; and selecting a class vector from the one or more class vectors having a highest similarity score, wherein the electronic device is configured to perform an operation associated with the selected class vector.

According to an aspect of the disclosure, an apparatus comprises: a memory storing one or more instructions; and a processor operatively coupled to the memory and configured to execute the one or more instructions stored in the memory, wherein the one or more instructions, when executed by the processor, cause the apparatus to: receive one or more training text sentences; generate one or more training vectors based on inputting the one or more training sentences input into a text encoder, the one or more training vectors corresponding to one or more operations that an electronic device is configured to perform; generate one or more speech vectors based on one or more speech utterances input into a speech encoder; generate a similarity matrix that compares each of the one or more training vectors with each of the one or more speech vectors; and update at least one of the text encoder and the speech encoder based on the similarity matrix.

### BRIEF DESCRIPTION OF DRAWINGS

Further features, the nature, and various advantages of the disclosed subject matter will be more apparent from the following detailed description and the accompanying drawings in which:

FIG. 1 is a diagram of an environment in which methods, apparatuses, and systems described herein may be implemented, in accordance with embodiments of the present disclosure.

FIG. 2 is a block diagram of example components of one or more devices of FIG. 1, in accordance with embodiments of the present disclosure.

FIG. 3A illustrates an example training scheme with speech and intent label data pairs, in accordance with embodiments of the present disclosure.

FIG. 3B illustrates an example training scheme with speech and transcription data pairs, in accordance with embodiments of the present disclosure.

FIG. 4 illustrates an example of training an intent classification system, in accordance with embodiments of the present disclosure.

FIG. 5 illustrates an example of using an intent classification system for inference, in accordance with embodiments of the present disclosure.

FIG. 6 illustrates an example of utilizing a large language model (LLM) with an intent classification system, in accordance with embodiments of the present disclosure.

FIG. 7 illustrates example text prompts input into a LLM, in accordance with embodiments of the present disclosure.

FIG. 8 illustrates example speaking patterns for different speakers, in accordance with embodiments of the present disclosure.

FIG. 9 illustrates a flow chart of an example process for training an intent classification system, in accordance with embodiments of the present disclosure.

FIG. 10 illustrates a flowchart of an example process for predicting an intent for a speech utterance, in accordance with embodiments of the present disclosure.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware or firmware. The actual specialized control hardware used to implement these systems and/or methods is not limiting of the implementations.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Reference throughout this specification to “one embodiment,” “an embodiment,” or similar language means that a particular feature, structure, or characteristic described in connection with the indicated embodiment is included in at least one embodiment of the present solution. Thus, the phrases “in one embodiment”, “in an embodiment,” and similar language throughout this specification may, but do not necessarily, all refer to the same embodiment.

Furthermore, the described features, advantages, and characteristics of the present disclosure may be combined in any suitable manner in one or more embodiments. One skilled in the relevant art will recognize, in light of the description herein, that the present disclosure may be practiced without one or more of the specific features or advantages of a particular embodiment. In other instances, additional features and advantages may be recognized in certain embodiments that may not be present in all embodiments of the present disclosure.

Existing intent classification system works only for the set of intent categories used during the training. To reuse it for a new set of intent categories for a new domain, fine-tuning is necessary that entails target domain data collection. Furthermore, existing models require a high amount of target domain data to model adaptation for a new domain since the pre-trained models cannot be trained with a large amount of data, due to scarcity of intent-annotated speech data.

In response to these limitations, the embodiments of the present disclosure introduce a novel, cost-efficient framework designed to enhance the generalizability of speech intent classification models without extensive intent-annotated data collection or domain-specific fine-tuning. Particularly, the embodiments of the present disclosure result in obtaining intent-annotated text data in a target domain with significantly improved efficiency.

The embodiments of the present disclosure provide a unique training strategy that leverages the capabilities of a text encoder, pre-trained on a vast corpus for broad intent classification, to augment a speech encoder's intent extraction proficiency. Particularly, the embodiments of the present disclosure pivot from a conventional (speech, intent) data pairing to a more accessible (speech, transcription) format. This shift facilitates training on a significantly larger dataset scale, promoting superior model generalization.

Furthermore, the embodiments of the present disclosure provide an innovative application method to use the resulting model in a new domain: employing a Large Language Model (LLM) for swift text data generation pertinent to the target domain. This strategy allows for the efficient creation of class embeddings essential for applying the trained model to different domains, circumventing the need for manual text data compilation and labeling. Through these advancements, the embodiments of the present disclosure set a new standard for developing versatile and cost-effective speech intent classification models.

As discussed above, self-supervised speech models enable effective fine-tuning. However, self-supervised speech models require supervised fine-tuning of a pre-trained model. This process may be circumvented with zero-shot learning. Once a model is trained, the model may be used without fine-tuning to classify inputs into new class categories, as long as the task is similar. In one or more embodiments, zero-shot speech intent classification is performed using systems built based on a variant of contrastive loss (CL). This approach alleviates the problem in the original CL when handling non-compatible pairs, which minimizes the similarities of the non-compatible pairs indiscriminately. However, these similarities are relative. For example, a pair of dog images, a pair of dog and cat images, and a pair of dog and airplane images would have similarity in decreasing order, which the original CL cannot tackle properly. Applying this concept to the original CL, performance may be significantly improved.

In one or more examples, the impact of including an in-domain (ID) intent classification corpus during the CL training on intent classification performance is assessed. Starting without any intent classification data, data is added until both text and speech encoders see the data from the respective modality from the ID corpus during training. Incorporating the ID corpus during the training enhances the system performance on the out-of-domain (OOD) data as well as ID data. Once the models are trained with CL, class embeddings may be generated for a set of intent classes. The similarity between the embedding of an input speech utterance and each class embedding may then calculated to predict the intent whose embedding is most similar to the input embedding. As the matrix of the class embedding vectors in zero-shot learning replaces the projection matrix of the classification head in supervised learning, generating accurate class embeddings is important. Therefore, methods to generate better class embeddings are explored, assuming there is no data in the target domain. The LLM-based method can achieve results comparable to when available human-collected text sentences per class are used to generate the class embeddings.

Embodiments of the present disclosure are directed to speech intent classification including applying a contrastive loss variant that can outperform the original contrastive loss, using in-domain data inclusion during the zero-shot model training to improve performance on the out-of-domain data, and using an LLM to enable performant zero-shot intent classification without human collected text data from the target domain during inference.

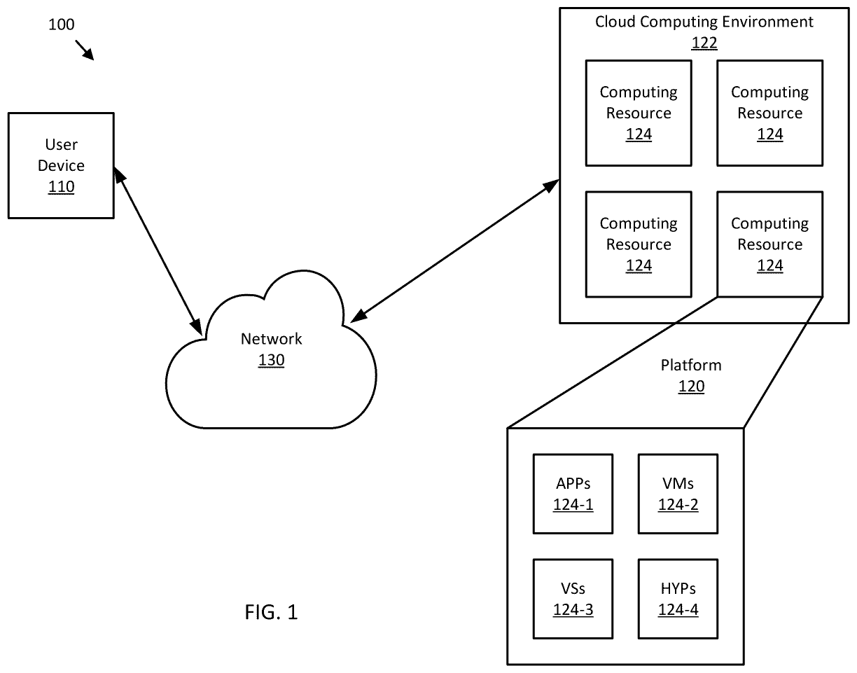

FIG. 1 is a diagram of an environment 100 in which methods, apparatuses, and systems described herein may be implemented, according to embodiments. As shown in FIG. 1, the environment 100 may include a user device 110, a platform 120, and a network 130. Devices of the environment 100 may interconnect via wired connections, wireless connections, or a combination of wired and wireless connections.

The user device 110 includes one or more devices capable of receiving, generating, storing, processing, and/or providing information associated with platform 120. For example, the user device 110 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, the user device 110 may receive information from and/or transmit information to the platform 120.

The platform 120 includes one or more devices as described elsewhere herein. In some implementations, the platform 120 may include a cloud server or a group of cloud servers. In some implementations, the platform 120 may be designed to be modular such that software components may be swapped in or out depending on a particular need. As such, the platform 120 may be easily and/or quickly reconfigured for different uses.

In some implementations, as shown, the platform 120 may be hosted in a cloud computing environment 122. Notably, while implementations described herein describe the platform 120 as being hosted in the cloud computing environment 122, in some implementations, the platform 120 may not be cloud-based (e.g., may be implemented outside of a cloud computing environment) or may be partially cloud-based.

The cloud computing environment 122 includes an environment that hosts the platform 120. The cloud computing environment 122 may provide computation, software, data access, storage, etc. services that do not require end-user (e.g. the user device 110) knowledge of a physical location and configuration of system(s) and/or device(s) that hosts the platform 120. As shown, the cloud computing environment 122 may include a group of computing resources 124 (referred to collectively as “computing resources 124” and individually as “computing resource 124”).

The computing resource 124 includes one or more personal computers, workstation computers, server devices, or other types of computation and/or communication devices. In some implementations, the computing resource 124 may host the platform 120. The cloud resources may include compute instances executing in the computing resource 124, storage devices provided in the computing resource 124, data transfer devices provided by the computing resource 124, etc. In some implementations, the computing resource 124 may communicate with other computing resources 124 via wired connections, wireless connections, or a combination of wired and wireless connections.

As further shown in FIG. 1, the computing resource 124 includes a group of cloud resources, such as one or more applications (APPs) 124-1, one or more virtual machines (VMs) 124-2, virtualized storage (VSs) 124-3, one or more hypervisors (HYPs) 124-4, or the like.

The application 124-1 includes one or more software applications that may be provided to or accessed by the user device 110 and/or the platform 120. The application 124-1 may eliminate a need to install and execute the software applications on the user device 110. For example, the application 124-1 may include software associated with the platform 120 and/or any other software capable of being provided via the cloud computing environment 122. In some implementations, one application 124-1 may send/receive information to/from one or more other applications 124-1, via the virtual machine 124-2.

The virtual machine 124-2 includes a software implementation of a machine (e.g. a computer) that executes programs like a physical machine. The virtual machine 124-2 may be either a system virtual machine or a process virtual machine, depending upon use and degree of correspondence to any real machine by the virtual machine 124-2. A system virtual machine may provide a complete system platform that supports execution of a complete operating system (OS). A process virtual machine may execute a single program, and may support a single process. In some implementations, the virtual machine 124-2 may execute on behalf of a user (e.g. the user device 110), and may manage infrastructure of the cloud computing environment 122, such as data management, synchronization, or long-duration data transfers.

The virtualized storage 124-3 includes one or more storage systems and/or one or more devices that use virtualization techniques within the storage systems or devices of the computing resource 124. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

The hypervisor 124-4 may provide hardware virtualization techniques that allow multiple operating systems (e.g. “guest operating systems”) to execute concurrently on a host computer, such as the computing resource 124. The hypervisor 124-4 may present a virtual operating platform to the guest operating systems, and may manage the execution of the guest operating systems. Multiple instances of a variety of operating systems may share virtualized hardware resources.

The network 130 includes one or more wired and/or wireless networks. For example, the network 130 may include a cellular network (e.g. a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g. the Public Switched Telephone Network (PSTN)), a private network, an ad hoc network, an intranet, the Internet, a fiber optic-based network, or the like, and/or a combination of these or other types of networks.

The number and arrangement of devices and networks shown in FIG. 1 are provided as an example. In practice, there may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally, or alternatively, a set of devices (e.g. one or more devices) of the environment 100 may perform one or more functions described as being performed by another set of devices of the environment 100.

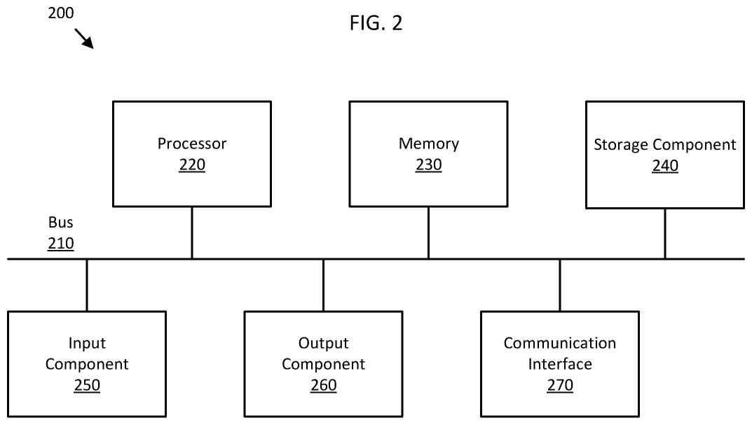

FIG. 2 is a block diagram of example components of one or more devices of FIG. 1. The device 200 may correspond to the user device 110 and/or the platform 120. The device 200 may be any other suitable device such as a TV, wall panel, etc. As shown in FIG. 2, the device 200 may include a bus 210, a processor 220, a memory 230, a storage component 240, an input component 250, an output component 260, and a communication interface 270.

The bus 210 includes a component that permits communication among the components of the device 200. The processor 220 is implemented in hardware, firmware, or a combination of hardware and software. The processor 220 is a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, the processor 220 includes one or more processors capable of being programmed to perform a function. The memory 230 includes a random access memory (RAM), a read only memory (ROM), and/or another type of dynamic or static storage device (e.g. a flash memory, a magnetic memory, and/or an optical memory) that stores information and/or instructions for use by the processor 220.

The storage component 240 stores information and/or software related to the operation and use of the device 200. For example, the storage component 240 may include a hard disk (e.g. a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive.

The input component 250 includes a component that permits the device 200 to receive information, such as via user input (e.g. a touch screen display, a keyboard, a keypad, a mouse, a button, a switch, and/or a microphone). Additionally, or alternatively, the input component 250 may include a sensor for sensing information (e.g. a global positioning system (GPS) component, an accelerometer, a gyroscope, and/or an actuator). The output component 260 includes a component that provides output information from the device 200 (e.g. a display, a speaker, and/or one or more light-emitting diodes (LEDs)).

The communication interface 270 includes a transceiver-like component (e.g., a transceiver and/or a separate receiver and transmitter) that enables the device 200 to communicate with other devices, such as via a wired connection, a wireless connection, or a combination of wired and wireless connections. The communication interface 270 may permit the device 200 to receive information from another device and/or provide information to another device. For example, the communication interface 270 may include an Ethernet interface, an optical interface, a coaxial interface, an infrared interface, a radio frequency (RF) interface, a universal serial bus (USB) interface, a Wi-Fi interface, a cellular network interface, or the like.

The device 200 may perform one or more processes described herein. The device 200 may perform these processes in response to the processor 220 executing software instructions stored by a non-transitory computer-readable medium, such as the memory 230 and/or the storage component 240. A computer-readable medium is defined herein as a non-transitory memory device. A memory device includes memory space within a single physical storage device or memory space spread across multiple physical storage devices.

Software instructions may be read into the memory 230 and/or the storage component 240 from another computer-readable medium or from another device via the communication interface 270. When executed, software instructions stored in the memory 230 and/or the storage component 240 may cause the processor 220 to perform one or more processes described herein. Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 2 are provided as an example. In practice, the device 200 may include additional components, fewer components, different components, or differently arranged components than those shown in FIG. 2. Additionally, or alternatively, a set of components (e.g. one or more components) of the device 200 may perform one or more functions described as being performed by another set of components of the device 200.

In one or more examples, the device 200 may be a controller of a smart home system that communicates with one or more sensors, cameras, smart home appliances, and/or autonomous robots. The device 200 may communicate with the cloud computing environment 122 to offload one or more tasks.

The embodiments of the present disclosure enable zero-shot speech intent classification. In prior systems, trained speech intent classifiers require further training on supervised dataset in a target domain to work (e.g., they are not zero-shot systems). The embodiments of the present disclosure provide a new system design for training a zero-shot speech intent classification system, which does not require further training for a new domain. The embodiments of the present disclosure include a training scheme that leverages the capabilities of a text encoder, previously trained on a vast corpus for broad intent classification, to augment a speech encoder's intent extraction proficiency.

In one or more examples, the system includes two encoders: a text model trained to extract an intent embedding vector, and a speech model that compresses information in an utterance into an embedding vector. A similarity loss may be used to make text and speech embeddings similar during training. In one or more examples, the speech encoder is trained in this training scheme while the other parts are fixed.

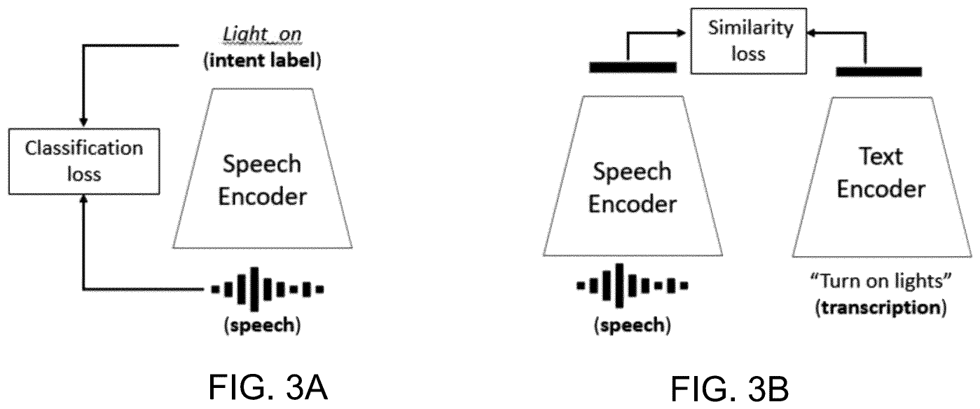

According to one or more embodiments, training may be performed with a new form of data pairs for better generalization. In prior systems, as illustrated in FIG. 3A, the main form of data pairs used for speech intent classification system training was (speech, intent label). However, the amount of the data with the intent annotations are sparse, which hinders direct deployment of a trained model to a new domain without further adjustment. FIG. 3B illustrates an example system with a speech encoder and a text encoder using a new training scheme with a different form of data pairs that are cheaper and more easily available: (speech, transcription) pairs. This training scheme enables model training with much larger data, which leads to better generalization of a trained model into a new domain.

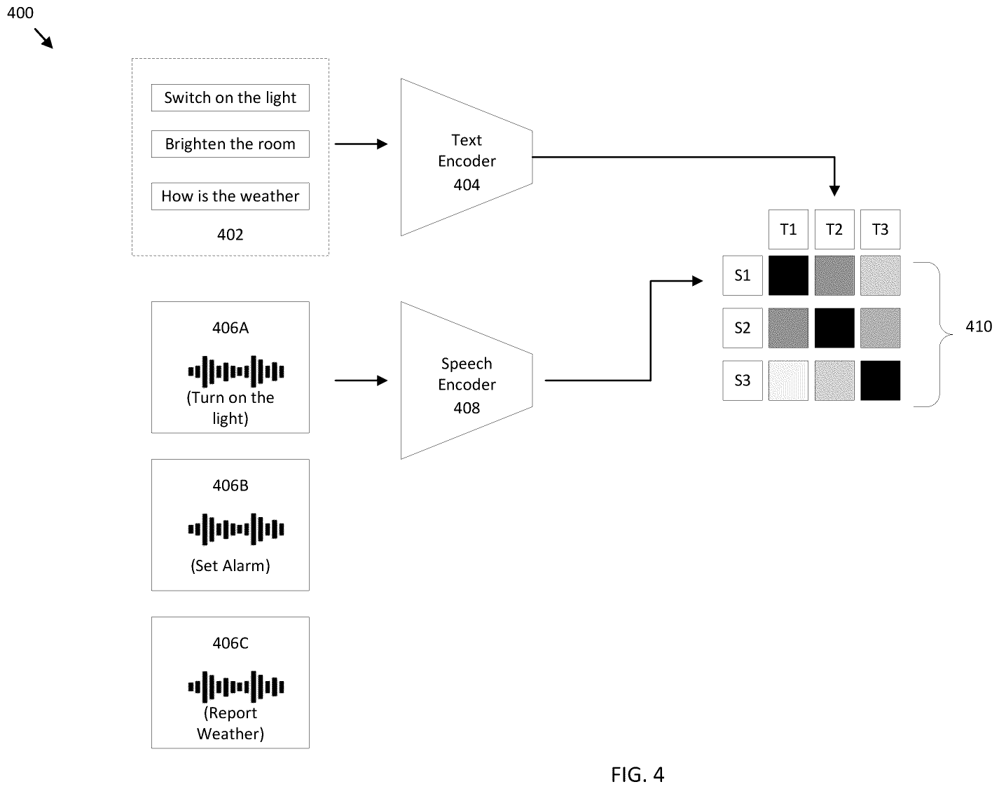

FIG. 4 illustrates an example intent classification system 400 during a training phase. During training, training sentences 402 are input into a text encoder 404. The training sentences may correspond to example sentences related to an action performed by an electronic device (e.g., turning on a light, reporting weather, etc.). Furthermore, during training, a speech encoder 408 receives one or more speech utterances 406A-406C. In one or more examples, the text encoder 404 and the speech encoder 408 may be implemented by individual circuitry, or may be implemented by the processor 202. In or more examples, the speech utterances 406A-406C may be pre-recorded utterances corresponding to different instructions that may be performed by an electronic device. For example, utterance 406A may be related to an instruction for turning on a light, utterance 406B may be related to an instruction for setting an alarm, and utterance 406C may be related to an instruction for reporting weather.

The text encoder 404 may provide one or more training embeddings T1-T3 (e.g., training vectors) corresponding to the training sentences 402. Each training embedding may correspond to a function that an electronic device is configured to perform (e.g., turning light on, setting alarm, increasing a volume). The training embeddings may be an average of the training sentences 402. For example, the sentences “Switch on light” and “Brighten the room,” which are sentences related to turning on a light, the training embedding may be “increase lighting” or “turn light on.” The output of the speech encoder 408 may output speech embeddings S1-S3 (e.g., speech vector). The speech embedding may be a shortened utterance with respect to the input utterance. In one or more examples, each training sentence may be associated with a semantic label such as “alarm_query”, “light_query”, “weather_query”. Accordingly, each training sentence with the same semantic label may be averaged together by the text encoder 404.

The speech embeddings S1-S3 and the training embeddings T1-T3 may be arranged to form a similarity matrix 410. In one or more examples, in the similarity matrix 410 during training, darker color means higher weight in Semantic Similarity-aware Contrastive Loss (SSCL), where the sum of the weights along the column is 1. The loss guides the cross-modal pair similarities in each column to follow the relative weights along the column.

In one or more examples, during training, the original contrastive loss (CL) is modified to address an issue. In the original CL, all incompatible pair terms in the denominators are minimized indiscriminately. However, one incompatible pair could be more similar than another non-compatible pair. For instance, a pair of dog images, a pair of dog and cat images, and a pair of dog and airplane images would have similarity in decreasing order, rather than the first pair being 1 and the other two being −1 as in the original CL. This concept is represented in the modified loss (SSCL) below:

$${ℒ}_{SSCL} = - \frac{1}{N} {\sum }_{i = 1}^{N} {\sum }_{j = 1}^{N} {\hat{w}}_{ij} log \frac{exp ( 〈 {t}_{i} , {s}_{j} 〉 / τ )}{{\sum }_{{j}^{*} = 1}^{N} exp ( 〈 {t}_{i} , {s}_{{j}^{*}} 〉 / τ )} \qquad Eq . ( 1 )$$

In the above equation, [symbol] a, b [symbol] denotes the cosine similarity between a and b vectors. The parameters t_{*} and s_{*} stand for text and speech embeddings, respectively. The parameter ŵᵢⱼ denotes the normalized text semantic similarity weight between tᵢ and tⱼ in the text modality. This parameter may be referred to as a weight. The weight may signal relative importance over cross-modal pair similarities in a batch, making the loss emphasize pairs with higher weights more than those with lower weights.

In one or more examples, the weights are determined as follows:

$${\hat{w}}_{ij} = {w}_{ij} / {\sum }_{{j}^{′} = 1}^{N} {w}_{{ij}^{′}} \qquad Eq . ( 2 )$$

$${w}_{ij} = 〈 {t}_{i} , {t}_{j} 〉 / 2 + 0.5 \qquad Eq . ( 3 )$$

In the above equations, wᵢⱼ∈[0, 1]. In one or more examples, two pre-trained text encoders may be used in sentence embedding extraction for the weight calculation to reflect sentence semantics in the weighing process. The parameter N is the number of samples in each modality per batch, and τ is a scaling factor to ensure training stability. This loss may be added to the original CL, which is then divided by two. The resulting loss may be the SSCL.

According to one or more embodiments, after the similarity matrix 410 is computed, at least one of the text encoder 404 and the speech encoder 408 is updated. For example, one or more weights associated with the text encoder 404 and/or the speech encoder 408 may be updated where the training process is repeated until each element in a similarity matrix 410 represents a similarity between the corresponding pair. In one or more examples, the text encoder 404 and/or the speech encoder 408 may be updated to optimize both the diagonal and non-diagonal of the similarity matrix 410. For example, the text encoder 404 and/or the speech encoder 408 may be updated such that the similarity scores between S1 and T1, S2 and T2, and S3 and T3 are high enough, and each similarity score between S1 and T2, S1 and T3, and S2 and S3 are adjusted proportionally to the semantic similarity in the corresponding pair. In one or more examples, the training and update process may be performed a predetermined number of iterations. The weights are updated to reduce the Eq. (1). This corresponds to change the similarity scores to be higher if a speech and text embedding pair is similar in semantics. For example, if S1 and T2 is more similar than S1 and T3, the similarity score between the former pair becomes higher than the latter during the training. When preparing the training dataset, we know that S1 and T1 (or S2 and T2, or S3 and T3) have the same semantics so the similarity score of the pair is highest than any other pairs. However, some of the similarity scores of the negative pairs, like S1 and T2, S1 and T3, S2 and T1, S2 and T3, S3 and T1, S3 and T2, could also be high if some of the pairs has similar meaning.

According to one or more embodiments, after the models are trained, class embeddings are generated for a new set of intents. Then, the similarity may be computed between each class embedding and an input speech embedding, to determine the class most similar to the input. Since this matrix of the class embedding vectors in zero-shot learning replaces the projection matrix of the classification head in supervised learning, generating accurate class embeddings is important. The embodiments of the present disclosure provide improved accuracy in the generation of class embeddings.

In one or more examples, after the models are trained, the models may be stored internally on the electronic device, where the models are utilized as the electronic device is utilized. In one or more examples, after training, the models may be downloaded onto the electronic device. In one or more examples, the electronic device may receive a software update where updated models are downloaded to the electronic device.

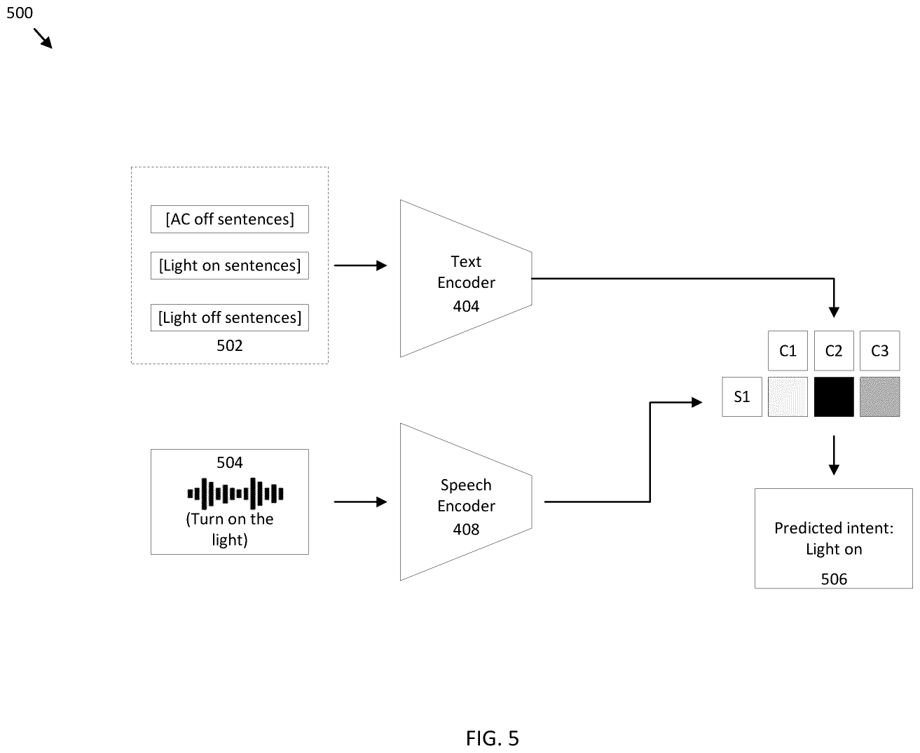

FIG. 5 illustrates an intent classification system 500 that has been trained. First, each class embedding (e.g., from C1 to C3) may be generated by averaging over the sentence-level text embeddings extracted by the text encoder 404 from a group of text sentences 502 in the corresponding intent class. Second, a user of the system speaks a sentence 504 to the system, which is converted by the speech encoder 408 to an utterance embedding S1 that is to be compared against the generated intent class embeddings from texts in the first step. Third, the prediction is made 506 by selecting a class most similar to the user's utterance embedding (e.g., C2). During inference, the darker color represents higher similarity between the speech embedding and the class embedding. Each class embedding in this diagram may be a vector averaged over embeddings of the sentences corresponding to the intent class.

The text class labels may be used as they are. For example, each class embedding is the text encoder output given the text class label as its input. In one or more examples, templates are applied to the consistently to class labels, such as “this is related to [class label].”, “this talks about [class label].”, “it is about [class label].”, etc. In one or more examples, the average of the embeddings extracted from each applied template to a class label may become the class embedding. However, this method may not be effective for speech intent classification.

Instead of using text class labels, a training subset's text data may be used. For example, multiple sentences that belong to the corresponding class may be used. The average of the generated embeddings from those sentences may become the class embedding. However, while this method shows the best result, this requires costly human-collected text data in the target domain.

An alternative method that does not require human-collected text data, in one or more examples, is to use text generation using a large language model (LLM) by devising prompts to enhance generation quality. For example, a prompt may indicate how data collection will occur, inducing the LLM to generate data that is similar to text data that human annotators might generate.

According to one or more embodiments, a LLM-assisted data generation process is utilized to reduce the cost of manual data collection and annotation for the trained model's application to a new target domain. When deploying a trained model, each class is generated by averaging embedding of sentences in the class (e.g., there is a group of sentences for [AC off] intent while another group of sentences for [Light on], [Light off], etc.). Annotating the text sentences to the corresponding intent classes is costly and time-consuming, accompanying human annotation. Therefore, to avoid this data collection and human annotation efforts for a target domain, a pre-trained large language model (LLM) is utilized.

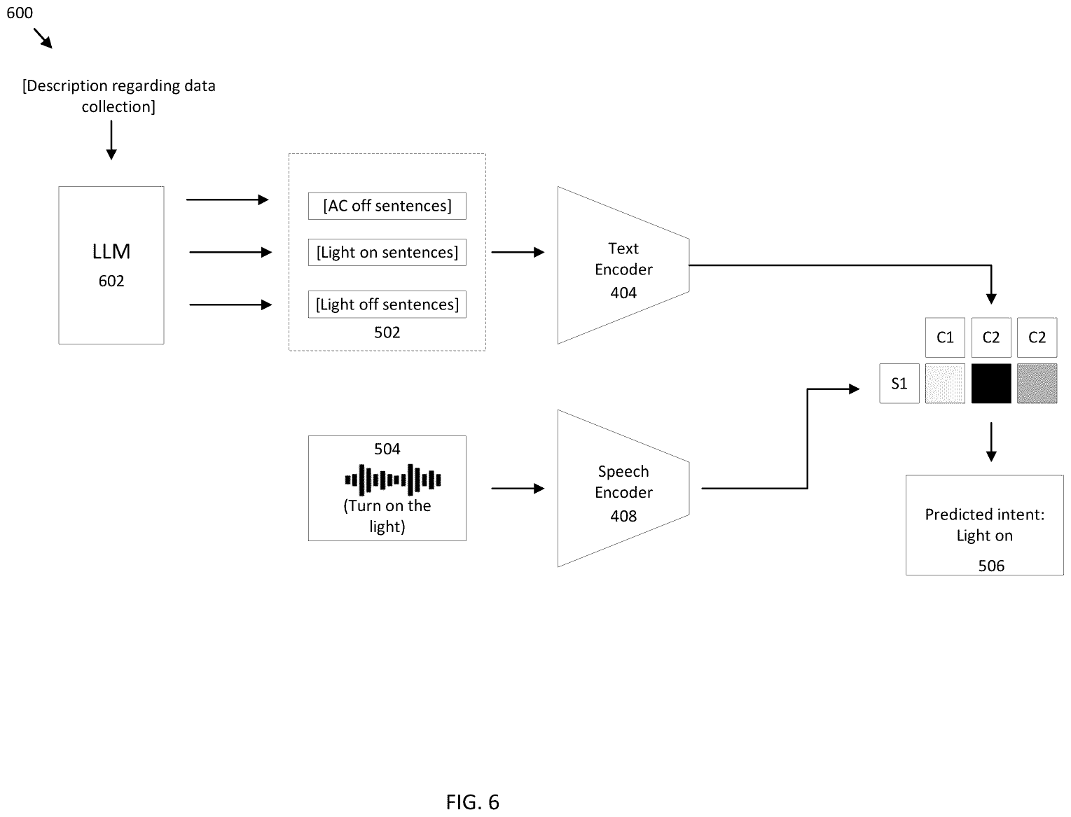

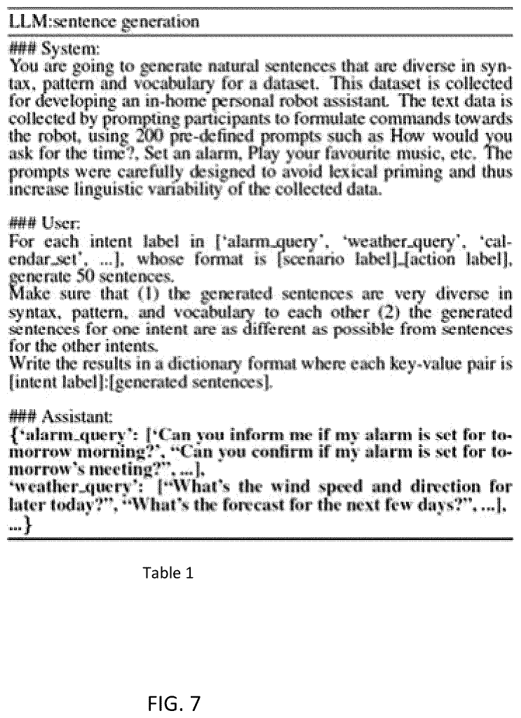

As illustrated in FIG. 6, the intent classification system 600 generates sentences 502 using a LLM 602. Table 1 in FIG. 7 illustrates example prompts to the LLM 602 with LLM responses boldfaced. The responses may be used to generate class embeddings for zero-shot intent classification. In Table 1, a description about the scenario where the data will be collected (e.g. The system prompt included in “### System:” block) includes the description that that data needs to be collected for the user's interaction with an in-home personal robot assistant with some constraints. In the user prompt (e.g., the “### User:” block), a list of target intent classes is given so that the LLM, may generate the pre-defined number of sentences for each of those classes. Example resulting samples generated by LLM is shown below “### Assistant:”. This LLM utilization advantageously avoids the human data collection and the annotation.

The LLM 602 may be used for the intent classification system 500 that has already been trained. For example, the LLM 602 may be used for a new function that is implemented by the electronic device.

As understood by one of ordinary skill in the art, a LLM may be an artificial intelligence (AI) program that uses machine learning to generate and understand language. LLMs may be trained on large amounts of text and other content, and can perform a variety of tasks, including, but not limited to: text generation, translation, sentiment analysis, question answering. LLMs may be built on deep learning architectures based on the idea of “attention,” where some neurons are more strongly connected to others in a sequence. This architecture may generate optimal results on text-based data because text is read in a sequence, with different parts of a sentence referring to or modifying others.

According to one or more embodiments, a LLM is a language model notable for its ability to achieve general-purpose language generation and other natural language processing tasks such as classification. They acquire these abilities by learning statistical relationships from text documents during a computationally intensive self-supervised and semi-supervised training process. LLMs can be used for text generation, a form of generative AI, by taking an input text and repeatedly predicting the next token or word.

Accordingly, LLMs rely on machine learning algorithms for training and generating an output based on an input query. Because machine learning algorithms may process numbers rather than text, the text may be converted to numbers. In a first step, a vocabulary is decided upon, then integer indexes are arbitrarily but uniquely assigned to each vocabulary entry, and finally, an embedding is associated to the integer index. Algorithms may include byte-pair encoding and WordPiece. Probabilistic tokenization also compress the datasets. Because LLMs generally require input to be an array that is not jagged, the shorter texts must be “padded” until they match the length of the longest one. How many tokens are, on average, needed per word depends on the language of the dataset.

In one or more examples, using a modification of byte-pair encoding, in a first step, all unique characters (including blanks and punctuation marks) are treated as an initial set of n-grams (e.g., initial set of uni-grams). Successively the most frequent pair of adjacent characters is merged into a bi-gram and all instances of the pair are replaced by it. All occurrences of adjacent pairs of (previously merged) n-grams that most frequently occur together are then again merged into even lengthier n-gram repeatedly until a vocabulary of prescribed size is obtained (in case of GPT-3, the size is 50257). Token vocabulary consists of integers, spanning from zero up to the size of the token vocabulary. New words can always be interpreted as combinations of the tokens and the initial-set uni-grams.

A token vocabulary based on the frequencies extracted from mainly English corpora uses as few tokens as possible for an average English word. An average word in another language encoded by such an English-optimized tokenizer is however split into suboptimal amount of tokens. GPT-2 tokenizer can use up to 15 times more tokens per word for some languages, for example for Shan language from Myanmar. Even more widespread languages such as Portuguese and German have “a premium of 50%” compared to English

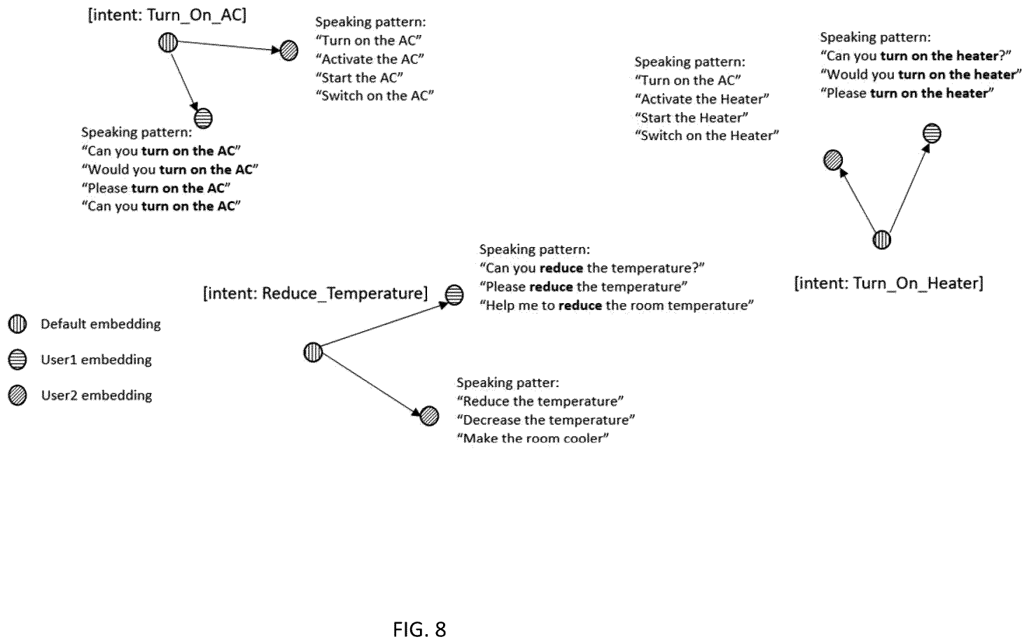

The embodiments of the present disclosure may be applied to control functions of an electronic device by connecting predicted intents to possible functions available on a device. Furthermore, in one or more examples the intent classification system may be customized by updating intent class embeddings based on the user's speaking patterns as in the figure below. As illustrated in FIG. 8, User1 asks for device control while using the limited vocabulary to describe the action. In contrast, User2 uses directives for device control with diverse vocabulary to imply the same thing. These two different user speaking patterns can be reflected to adjust the default embedding per intent class for customization.

The embodiments of the present disclosure may be used to perform device control on any suitable device such as refrigerators, cell phones, vacuum cleaners, smart watches, AR/VR glasses, earbuds, smart TVs, etc. If a new function is added to a device, a quick addition of the intent class for the function activation may be possible without model training. Furthermore, customized device control may be possible by adding specific sentences from a user to modify the class embedding.

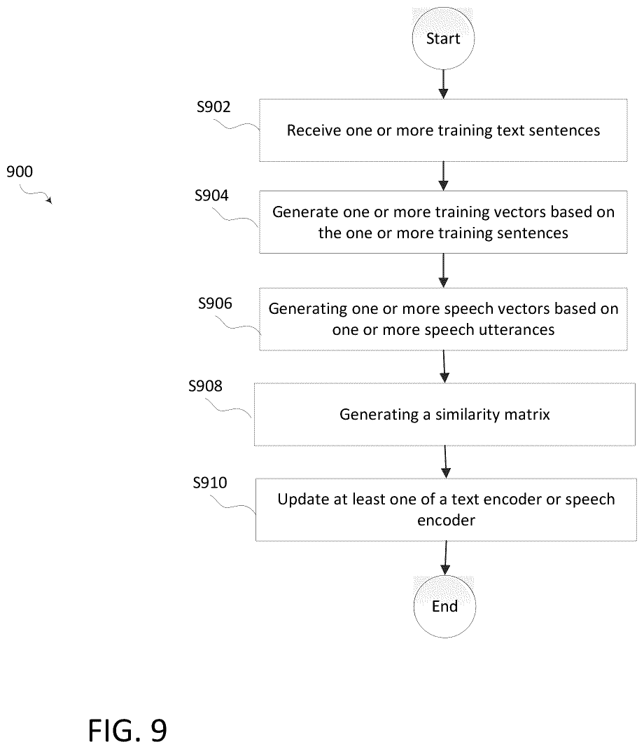

FIG. 9 illustrates a flowchart of an example process 900 of training an intent classification system such as the classification system 400 illustrated in FIG. 4. The process 900 may be performed by the processor 220 (FIG. 2).

The process may start at operation S902 where one or more training text sentences are received. In one or more examples, the training text sentences may be supervised data with annotated labels. In one or more examples, the training text sentences may be from a LLM based on one or more text prompts. For example, the text prompts illustrated in Table 1 (FIG. 7) may be input into LLM 602 to generate sentences 402.

The process proceeds to operation S904 where one or more training vectors are generated based on the one or more training sentences. For example, the sentences 402 may be input into the text encoder 404 to generate training vectors t1-t3.

The process proceeds to operation S906 where one or more speech vectors are generated based on one or more speech utterances. For example, the one or more speech utterances may be input into the speech encoder 408 to generate speech vectors s1-s3. In one or more examples, the speech utterances may be part of a predetermined set of pre-recorded utterances covering a range of instructions or commands. In one or more examples, the speech utterances may be captured in real-time and provided to the speech encoder 408.

The process proceeds to operation S908 where a similarity matrix is generated. For example, the similarity matrix 410 is generated based on training vectors t1-t3 and s1-s3 using Eq. (1).

The process proceeds to operation S910 where at least one of the text encoder or speech encoder are updated. For example, the text encoder or the speech encoder may be implemented by a machine learning model that may be adjusted for improved results. In one or more examples, the text encoder or the speech encoder may be adjusted such that the similarity scores between similar speech vectors and the text vectors are optimized. For example, the training may focus on creating a similarity matrix in which a similarity score has a higher value for a semantically more similar pair.

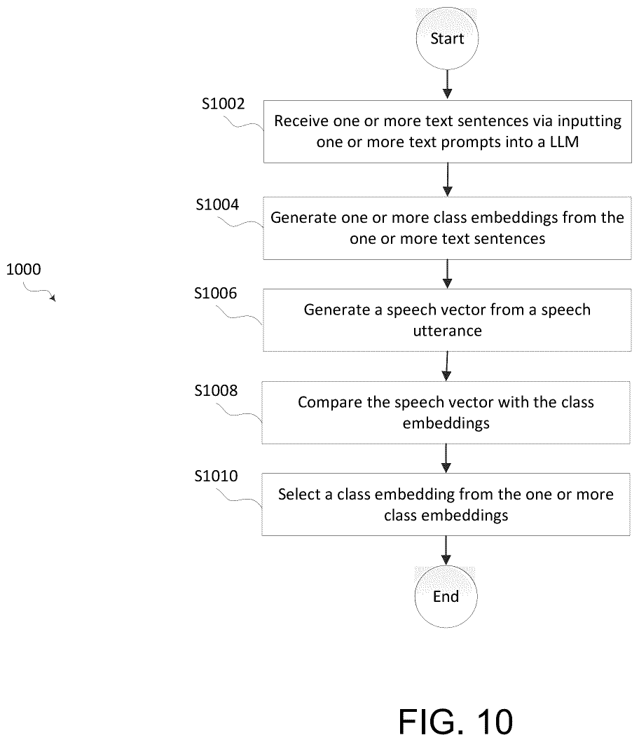

FIG. 10 illustrates an example process 1000 for generating class embeddings. In one or more examples, the process 1000 may be performed on text or speech encoders that have been trained according to the process illustrated in FIG. 9. The process 1000 may be performed by the processor 220 (FIG. 2).

The process may start at operation S1002 where one or more text sentences are received. In one or more examples, the text sentences may be received by inputting one or more text prompts into a LLM, as illustrated in Table 1 of FIG. 7.

The process proceeds to operation S1004, where one or more class embeddings are generated from the one or more text sentences. The one or more class embeddings may correspond to class embeddings c1-c3 in FIG. 6. The one or more class embeddings may be obtained by averaging the one or more text sentences. For example, each sentence may be associated with a label such as “turn_on_light,” “alarm_query,” etc. Accordingly, if class C1 is related to turning on a light, each sentence with the label “turn_on_light” is averaged to generate C1.

The process proceeds to operation S1006 where a speech vector is generated from a speech utterance. For example, speech utterance 504 (FIG. 5) may be input into speech encoder 408 to generate speech vector s1.

The process proceeds to operation S1008 where the speech vector is compared with the class embeddings generated in operation S1004. For example, a similarity score may be produced for each comparison. For examples, a first similarity score may be produced comparing S1 to C1, a second similarity score may be produced comparing S1 to C2, and a third similarity score may be produced comparing S1 to C3.

The process proceeds to operation S1010 where a class embedding is selected. For example, a class embedding with the highest similarity score generated in operation S1008 is selected. For example, if the speech vector S1 corresponds to a speech utterance such as “Turn on the light,” C1 is a class embedding related to turning on the light, C2 is a class embedding related to turning on an alarm, and C3 is a class embedding related to a weather query, the similarity score between C1 and S1 will be higher than the other similarity scores. Therefore, C1 will be selected. In one or more examples, after C1 is selected, an instruction may be generated that causes an electronic device to automatically perform an instruction related to the class embedding (e.g., electronic device turns on a light).

The embodiments have been described above and illustrated in terms of blocks, as shown in the drawings, which carry out the described function or functions. These blocks may be physically implemented by analog and/or digital circuits including one or more of a logic gate, an integrated circuit, a microprocessor, a microcontroller, a memory circuit, a passive electronic component, an active electronic component, an optical component, and the like, and may also be implemented by or driven by software and/or firmware (configured to perform the functions or operations described herein). The circuits may, for example, be embodied in one or more semiconductor chips, or on substrate supports such as printed circuit boards and the like. Circuits included in a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks. Likewise, the blocks of the embodiments may be physically combined into more complex blocks.

While this disclosure has described several non-limiting embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

The above disclosure also encompasses the embodiments listed below:

(1) A method performed by at least one processor, the method including: receiving one or more training text sentences; generating one or more training vectors based on inputting the one or more training sentences input into a text encoder, the one or more training vectors corresponding to one or more operations that an electronic device is configured to perform; generating one or more speech vectors based on one or more speech utterances input into a speech encoder; generating a similarity matrix that compares each of the one or more training vectors with each of the one or more speech vectors; and updating at least one of the text encoder and the speech encoder based on the similarity matrix.

(2) The method according to feature (1), in which the one or more training text sentences are received from a supervised dataset that labels each text sentence from the one or more text sentences with a label corresponding to an operation from the one or more operations.

(3) The method according to feature (1) or (2), in which the similarity matrix comprises comparing each training vector from the one or more training vectors with each speech vector from the one or more speech vectors by determining a similarity score between a respective training vector and a respective speech vector that indicates a degree of similarity between the respective training vector and the respective speech vector.

(4) The method according to any one of features (1)-(3), in which a sum of each of the similarity scores in each column of the similarity matrix is 1.

(5) The method according to any one of features (1)-(4), in which each diagonal entry in the similarity matrix has a higher similarity score than a non-diagonal entry.

(6) The method according to feature (5) in which at least one non-diagonal entry in the similarity matrix has a value between −1 and 1.

(7) The method according to any one of features (1)-(6), the updating includes updating at least one of the text encoder and the speech encoder such that a first pair of a speech vector and a training vector in the similarity matrix that has a higher degree of similarity than a second pair of a speech vector and a training vector has a higher similarity score.

(8) A method performed by at least one processor, the method including: receiving, from a large language model, one or more text sentences based on one or more text prompts input into the LLM; generating one or more class vectors based on the one or more text sentences input into a pre-trained text encoder, the one or more class vectors corresponding to one or more operations that an electronic device is configured to perform; generating a speech vector based on a speech utterance input into a pre-trained speech encoder; generating a similarity score between each class vector and the speech vector; and selecting a class vector from the one or more class vectors having a highest similarity score, in which the electronic device is configured to perform an operation associated with the selected class vector.

(9) The method according to feature (8), in which the one or more text prompts comprise an instruction that instructs the LLM to generate N different sentences corresponding to the one or more operations of the electronic device.

(10) The method according to feature (9), in which each of the N different sentences is associated with a scenario label corresponding to a respective operation of the one or more operations of the electronic device.

(11) The method according to feature (10), in which the text encoder performs an averaging of sentences having a same scenario label to generate a respective class vector.

(12) The method according to feature (8), in which the one on or more class vectors includes at least one class vector corresponding to an operation in which that was not used in the training of the pre-trained text encoder or the pre-trained speech encoder.

(13) The method according to claim 9, wherein at least one of the pre-trained text encoder and the pre-trained speech encoder is trained with a supervised dataset.

(14) An apparatus comprising: a memory storing one or more instructions; and a processor operatively coupled to the memory and configured to execute the one or more instructions stored in the memory, in which the one or more instructions, when executed by the processor, cause the apparatus to: receive one or more text sentences; generate one or more training vectors based on inputting the one or more training sentences input into a text encoder, the one or more training vectors corresponding to one or more operations that an electronic device is configured to perform; generate one or more speech vectors based on one or more speech utterances input into a speech encoder; generate a similarity matrix that compares each of the one or more training vectors with each of the one or more speech vectors; and update at least one of the text encoder and the speech encoder based on the similarity matrix.

(15) The apparatus according to feature (14), in which the one or more text sentences are received from a supervised dataset that labels each text sentence from the one or more text sentences with a label corresponding to an operation from the one or more operations.

(16) The apparatus according to feature (14) or (15), in which the similarity matrix comprises comparing each training vector from the one or more training vectors with each speech vector from the one or more speech vectors by determining a similarity score between a respective training vector and a respective speech vector that indicates a degree of similarity between the respective training vector and the respective speech vector.

(17) The apparatus according to any one of features (14)-(16), in which a sum of each of the similarity scores in each column of the similarity matrix is 1.

(18) The apparatus according to any one of features (14)-(17), in which each diagonal entry in the similarity matrix has a higher similarity score than a non-diagonal entry.

(19) The apparatus according to features (18), in which at least one non-diagonal entry in the similarity matrix has a value between −1 and 1.

(20) The apparatus according to any one of features (14)-(19), in which the one or more instructions, when executed by the processor, cause the apparatus to: update of the at least one text encoder and the speech encoder comprises updating at least one of the text encoder and the speech encoder such that a first pair of a speech vector and a training vector in the similarity matrix that has a higher degree of similarity than a second pair of a speech vector and a training vector has a higher similarity score.

What is claimed is:

1. A method performed by at least one processor, the method comprising:
receiving one or more training text sentences;
generating one or more training vectors based on inputting the one or more training sentences input into a text encoder, the one or more training vectors corresponding to one or more operations that an electronic device is configured to perform;
generating one or more speech vectors based on one or more speech utterances input into a speech encoder;
generating a similarity matrix that compares each of the one or more training vectors with each of the one or more speech vectors; and
updating at least one of the text encoder and the speech encoder based on the similarity matrix.

2. The method according to claim 1, wherein the one or more training text sentences are received from a supervised dataset that labels each text sentence from the one or more text sentences with a label corresponding to an operation from the one or more operations.

3. The method according to claim 1, wherein the similarity matrix comprises comparing each training vector from the one or more training vectors with each speech vector from the one or more speech vectors by determining a similarity score between a respective training vector and a respective speech vector that indicates a degree of similarity between the respective training vector and the respective speech vector.

4. The method according to claim 1, wherein a sum of each of the similarity scores in each column of the similarity matrix is 1.

5. The method according to claim 1, wherein each diagonal entry in the similarity matrix has a higher similarity score than a non-diagonal entry.

6. The method according to claim 5, wherein at least one non-diagonal entry in the similarity matrix has a value between −1 and 1.

7. The method according to claim 1, wherein the updating comprises updating at least one of the text encoder and the speech encoder such that a first pair of a speech vector and a training vector in the similarity matrix that has a higher degree of similarity than a second pair of a speech vector and a training vector has a higher similarity score.

8. A method performed by at least one processor, the method comprising:
receiving, from a large language model, one or more text sentences based on one or more text prompts input into the LLM;
generating one or more class vectors based on the one or more text sentences input into a pre-trained text encoder, the one or more class vectors corresponding to one or more operations that an electronic device is configured to perform;
generating a speech vector based on a speech utterance input into a pre-trained speech encoder;
generating a similarity score between each class vector and the speech vector; and
selecting a class vector from the one or more class vectors having a highest similarity score,
wherein the electronic device is configured to perform an operation associated with the selected class vector.

9. The method according to claim 8, wherein the one or more text prompts comprise an instruction that instructs the LLM to generate N different sentences corresponding to the one or more operations of the electronic device.

10. The method according to claim 9, wherein each of the N different sentences is associated with a scenario label corresponding to a respective operation of the one or more operations of the electronic device.

11. The method according to claim 10, wherein the text encoder performs an averaging of sentences having a same scenario label to generate a respective class vector.

12. The method according to claim 8, wherein the one on or more class vectors includes at least one class vector corresponding to an operation that was not used in the training of the pre-trained text encoder or the pre-trained speech encoder.

13. The method according to claim 9, wherein at least one of the pre-trained text encoder and the pre-trained speech encoder is trained with a supervised dataset.

14. An apparatus comprising:
a memory storing one or more instructions; and
a processor operatively coupled to the memory and configured to execute the one or more instructions stored in the memory,
wherein the one or more instructions, when executed by the processor, cause the apparatus to:
receive one or more training text sentences;
generate one or more training vectors based on inputting the one or more training sentences input into a text encoder, the one or more training vectors corresponding to one or more operations that an electronic device is configured to perform;
generate one or more speech vectors based on one or more speech utterances input into a speech encoder;
generate a similarity matrix that compares each of the one or more training vectors with each of the one or more speech vectors; and
update at least one of the text encoder and the speech encoder based on the similarity matrix.

15. The apparatus according to claim 14, wherein the one or more training text sentences are received from a supervised dataset that labels each text sentence from the one or more text sentences with a label corresponding to an operation from the one or more operations.

16. The apparatus according to claim 14, wherein the similarity matrix comprises comparing each training vector from the one or more training vectors with each speech vector from the one or more speech vectors by determining a similarity score between a respective training vector and a respective speech vector that indicates a degree of similarity between the respective training vector and the respective speech vector.

17. The apparatus according to claim 14, wherein a sum of each of the similarity scores in each column of the similarity matrix is 1.

18. The apparatus according to claim 14, wherein each diagonal entry in the similarity matrix has a higher similarity score than a non-diagonal entry.

19. The apparatus according to claim 18, wherein at least one non-diagonal entry in the similarity matrix has a value between −1 and 1.

20. The apparatus according to claim 14, wherein the one or more instructions, when executed by the processor, cause the apparatus to:
update of the at least one text encoder and the speech encoder comprises updating at least one of the text encoder and the speech encoder such that a first pair of a speech vector and a training vector in the similarity matrix that has a higher degree of similarity than a second pair of a speech vector and a training vector has a higher similarity score.
